(19) United States
(12) Patent Application Publication
(10) Pub. No.: US 2016/0066616 A1
(43) Pub. Date: Mar. 10, 2016

(54) JUICER AND ATTACHMENT FOR JUICER

(71) Applicant: Panasonic Intellectual Property Management Co., Ltd., Osaka (JP)

(72) Inventors: NAOKI YAMAGUCHI, Shiga (JP); SHINGO OMURA, Shiga (JP)

(21) Appl. No.: 14/842,882

(22) Filed: Sep. 2, 2015

(30) Foreign Application Priority Data
Sep. 5, 2014 (JP) 2014-181559

(51) Int. Cl. A23N 1/02

(52) U.S. Cl. CPC A23N 1/02

(57) ABSTRACT

A juicer includes a screw, attachment, container, a lid, and a main unit. Attachment has the screw disposed internally, and crushes frozen material between an inner surface and the screw. Container has first spout for discharging the crushed material. The lid includes a feed opening for the material, and is disposed on upper part of container. A main unit has a mount section on an upper part for placing container, and drives the screw. Attachment has drum section for crushing the frozen material between the inner surface and the screw, and second spout connected to an inlet of first spout for guiding the crushed material into first spout. A first rib is provided in first spout for prevention of finger insertion, and second rib is disposed in second spout at a position corresponding to the first rib. This structure can discharge the frozen material in fluid form smoothly from inside of the attachment to outside of the container.

### TECHNICAL FIELD

The present disclosure relates to a juice extractor (“juicer”) for making juice by squeezing or crushing various materials such as vegetables, fruits and cereals. More specifically, the present disclosure relates to an attachment for a juicer (“attachment”) for crushing frozen materials.

### BACKGROUND ART

There have been products of various structures hitherto known as juicers. A conventional juicer includes, for instance, a container, an attachment having a net-like section disposed inside the container for straining juice, a screw disposed inside the attachment, and a main unit configured to hold the container on it and drive the screw to rotate.

In such a juicer, materials such as fruits are squeezed between an outer surface of the screw being rotated and an inner surface of the attachment, and juice that passes through the net-like section of the attachment is taken out from a spout of the container (refer to Japanese Translation of PCT Publication, No. 2011-527229, for example).

Some juicers known in recent years are of such a kind that is equipped with an attachment having a screw capable of crushing frozen materials (e.g., frozen fruits) to make dessert in a form of sherbet or ice cream.

Dessert of a type produced by crushing frozen materials is generally called “Yonanas” (Registered Trademark), and attracting attention as hypocaloric desserts or sweets of new tastes.

Referring to FIG. 12 and FIG. 13, description is provided here about a structure of a conventional juicer equipped with an attachment described above. FIG. 12 is an external view of the conventional juicer, and FIG. 13 is an exploded view of a container and related components of the juicer.

As shown in FIG. 13, juicer 51 includes container 52, attachment 53 disposed in container 52, screw 54 disposed inside attachment 53, and lid 55 placed on an upper part of container 52.

Lid 55 is provided with feed opening 56 for frozen materials. Container 52 has first spout 61 for material in fluid form. Attachment 53 has second spout 62 for the material in fluid form.

These members are mounted on an upper part of main unit 60 together with container 52, so that, under this mounted state shown in FIG. 12, screw 54 becomes rotatable when driven by a drive unit (not shown) built inside main unit 60.

When frozen materials are charged from feed opening 56, the frozen materials are crushed between an outer surface of rotating screw 54 and an inner surface of attachment 53, and turned into a material in fluid form. The material in fluid form thus produced is guided into first spout 61 of container 52 through second spout 62 of attachment 53, and the material is discharged from first spout 61.

Juicer 51 has a rib (not shown) provided in first spout 61 of container 52 in order to prevent insertion of a finger in consideration of safety of the user. A flow channel inside first spout 61 is divided practically into a plurality (two or three, for instance) of passages by the rib.

### SUMMARY OF THE INVENTION

An outlet of second spout 62 of attachment 53 is connected to an inlet of first spout 61 of container 52 (they are located adjacent to each other). The material in fluid form produced from the crushed frozen materials has a higher viscosity than that of juice.

It is therefore difficult to guide the material smoothly into first spout 61 from second spout 62 due to the rib for preventing insertion of finger that becomes a flow resistance inside first spout 61 when the material is being guided to first spout 61. As a result, it is likely that the material leaks out into container 52 through a space in the connecting section between first spout 61 and second spout 62.

Second spout 62 of attachment 53 has near a semi-cylindrical shape having an opening formed in a lower part of the cylindrical section, as shown in FIG. 13, and there is also a possibility that a large amount of the material leaks out into container 52 from this opening.

Consequently, when frozen material is used in the conventional juicer, the material that leaks out from second spout 62 of attachment 53 sticks to the inner surface of container 52, and it results in an increase in the time-consuming task of cleaning.

If a sealing material such as a gasket is installed in the connecting section between first spout 61 and second spout 62 to solve these problems, it brings about an increase in not only a number of components but also the time to clean the sealing material.

The present disclosure addresses the above problems of the conventional art, and is aimed at providing an attachment for crushing frozen material and a juicer equipped with the attachment that, when mounted onto the juicer, can discharge the frozen material in fluid form smoothly from inside of the attachment to outside of a container.

To achieve the above object, the attachment of the present disclosure, or a juicer equipped with the attachment, is constructed as described hereinafter.

A juicer according to one embodiment of the present disclosure includes a screw configured to be driven and rotated, an attachment having the screw disposed internally to crush frozen material between an inner surface and the screw, a container having a first spout for discharging the crushed material in fluid form, a lid having a feed opening of the material and placed on an upper part of the container, and a main unit having a mount section for the container on an upper part and configured to drive the screw to rotate.

The attachment includes a drum section configured to crush the frozen material between the inner surface and the screw, and a second spout connected to an inlet of the first spout of the container for guiding the crushed material in fluid form into the first spout. A first rib is provided in the first spout of the container in order to prevent insertion of a finger. A second rib is provided in the second spout of the attachment at a position corresponding to the first rib.

An attachment for a juicer according to another embodiment of the present disclosure has a screw disposed internally, and the screw is driven and rotated so that frozen material is crushed between an inner surface of the attachment and the screw.

This attachment is used for a juicer that includes a container having a first spout for discharging crushed material in fluid form, a lid having a feed opening for the material and placed on an upper part of the container, and a main unit having a mount section for the container on an upper part and configured to drive the screw to rotate.

This attachment includes a drum section configured to crush frozen material between an inner surface and the screw, and a second spout connected to the inlet of the first spout of the container for guiding the crushed material in fluid form into the first spout, wherein the attachment is provided with a second rib in the second spout of the attachment at a position corresponding to the first rib provided in the first spout of the container in order to prevent insertion of a finger.

According to the above embodiments, the attachment for crushing frozen material, when mounted onto the juicer, can discharge the frozen material in fluid form smoothly from inside of the attachment to outside of the container.

### BRIEF DESCRIPTION OF DRAWINGS

FIG. 1 is an external view of a juicer according to one exemplary embodiment of the present disclosure.

FIG. 2 is an exploded view of the juicer according to the exemplary embodiment.

FIG. 3 is an exploded view of the juicer (i.e., a container and an inner structure) according to the exemplary embodiment.

FIG. 4 is an external view of an attachment included in the juicer according to the exemplary embodiment.

FIG. 5 is a relational drawing (exploded view) of the attachment, a container and a screw according to the exemplary embodiment.

FIG. 6 is a cutaway view of the container with the attachment in a mounted state according to the exemplary embodiment.

FIG. 7 is a cutaway view of the attachment mounted inside the container according to the exemplary embodiment.

FIG. 8 is a cutaway view of the container to be used with the juicer according to the exemplary embodiment.

FIG. 9 is an external view (partially sectioned view) of the container for the juicer according to the exemplary embodiment, showing a state when a second spout of the attachment is observed through a first spout of the container.

FIG. 10 is an external view of an attachment in a first aspect of variation according to the exemplary embodiment.

FIG. 11 is an external view of another attachment in a second aspect of variation according to the exemplary embodiment.

FIG. 12 is an external view of a conventional juicer.

FIG. 13 is an exploded view a container and related components of the conventional juicer.

### DETAILED DESCRIPTION OF THE INVENTION

A juicer according to a first aspect of the present disclosure includes a screw configured to be driven and rotated, an attachment having the screw disposed internally to crush frozen material between an inner surface and the screw, a container having a first spout for discharging the crushed material in fluid form, a lid having a feed opening for the material and placed on an upper part of the container, and a main unit having a mount section for the container on an upper part and for driving the screw to rotate.

The attachment includes a drum section configured to crush the frozen material between an inner surface and the screw, and a second spout connected to an inlet of the first spout of the container for guiding the crushed material of the fluid form into the first spout. A first rib is provided in the first spout of the container in order to prevent insertion of a finger. A second rib is provided in the second spout of the attachment at a position corresponding to the first rib.

According to the present aspect, the second rib provided in the second spout at the position corresponding to the first rib of the container helps rectify flow of the frozen material when the material of the fluid form passes through the second spout of the attachment.

The material can be thus guided smoothly from the second spout to the first spout. As a result, the attachment for crushing the frozen material, when mounted onto the juicer, can discharge the frozen material of the fluid form smoothly from inside of the attachment to outside of the container.

A juicer according to a second aspect of the present disclosure is so configured in the structure of the first aspect that a cross sectional area of a flow channel of the second spout at the position where the second rib is formed in the attachment is formed smaller than that of a flow channel of the first spout at a position where the first rib is formed in the container.

According to the present aspect, the structure can suppress an increase in flow resistance in an inlet side of the first spout when the frozen material in fluid form is guided from the second spout to the first spout, thereby smoothing the flow of the material.

A juicer according to a third aspect of the present disclosure includes a second rib provided at least at an outlet side of the second spout of the attachment, in any of the structures of the first and the second aspects.

According to the present aspect, the structure can rectify the flow of frozen material in fluid form at least on the outlet side of the second spout that corresponds to the position where the first rib is formed in the first spout. As a result, it can suppress an increase in the flow resistance at the inlet side of the first spout, and smooth the flow of the material.

A juicer according to a fourth aspect of the present disclosure has the second rib so formed as to extend from the inlet side to the outlet side of the second spout of the attachment, in any of the structures of the first to the third aspects.

With the structure of the present aspect, the material that tends to be clogged due to the second rib that becomes a flow resistance at the inlet side of the second spout can be scraped off with the screw at an inner surface of the drum section of the attachment, thereby helping to smooth the flow of the material.

A juicer according to a fifth aspect of the present disclosure has the second spout formed into a cylindrical shape that protrudes outward from an outer surface of the drum section of the attachment, in any of the structures of the first to the fourth aspects.

According to the present aspect, the structure can prevent the material from leaking into the container and sticking to the inner surface of the container, thereby helping to guide the material smoothly from the second spout of the attachment to the first spout of the container.

An attachment for a juicer according to a sixth aspect of the present disclosure is provided internally with a screw configured to be driven and rotated so that frozen material is crushed between an inner surface of the attachment and the screw.

This attachment is used for a juicer that includes a container having a first spout for discharging crushed material in fluid form, a lid having a feed opening for the material and placed on an upper part of the container, and a main unit having a mount section for the container on an upper part and for driving the screw to rotate.

This attachment includes a drum section configured to crush frozen material between the inner surface and the screw, and a second spout connected to an inlet of the first spout of the container for guiding the crushed material in fluid form into the first spout, wherein the attachment is provided with a second rib in the second spout of the attachment at a position corresponding to a first rib provided in the first spout of the container in order to prevent insertion of a finger.

According to the present aspect, the second rib provided in the second spout at the position corresponding to the first rib of the container can rectify the flow of the frozen material when the material of the fluid form passes through the second spout of the attachment.

The material can thus be guided smoothly from the second spout to the first spout. As a result, the attachment for crushing frozen material, when mounted to the juicer, can discharge the frozen material in fluid form smoothly from the inside of the attachment to the outside of the container.

### Exemplary Embodiment

Description is provided hereinafter of an exemplary embodiment of the present disclosure in detail by referring to the accompanying drawings.

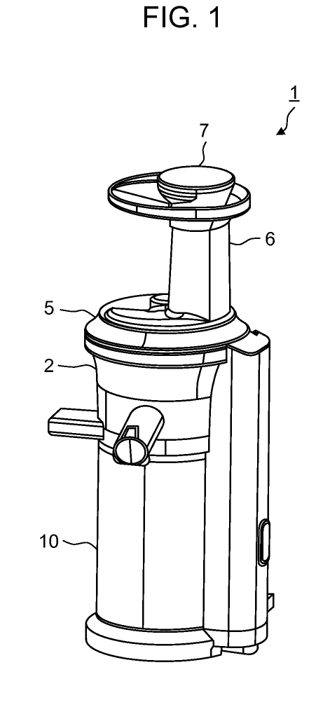

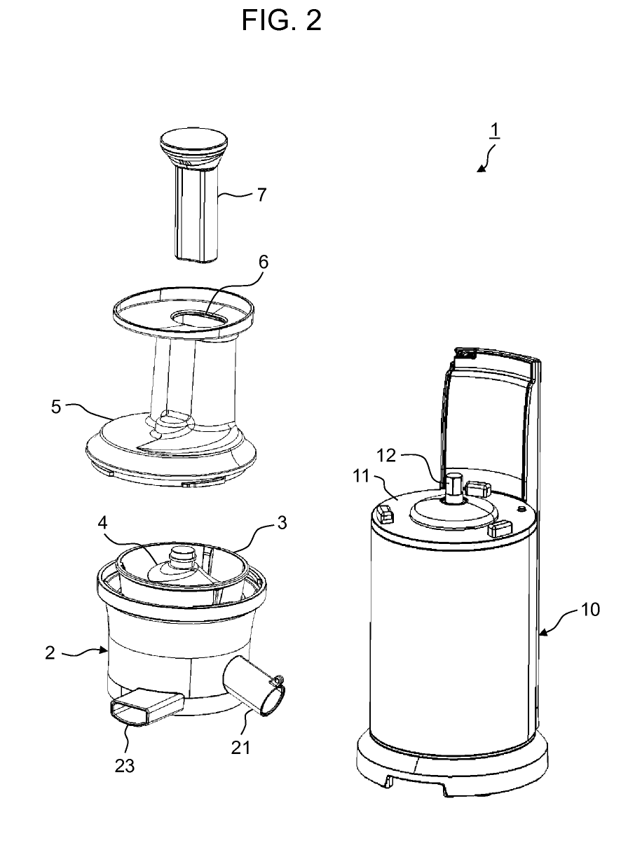

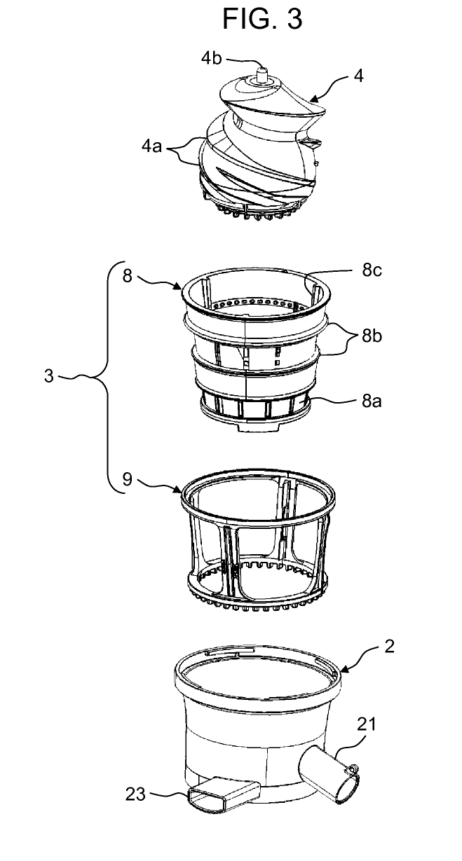

FIG. 1 is an external view of juicer 1 according to the exemplary embodiment of the present disclosure. FIG. 2 and FIG. 3 are exploded views of juicer 1 according to this exemplary embodiment. More specifically, FIG. 3 is an exploded view that illustrates a structure of juicer 1, except a main unit, a lid and a push rod (i.e., a container and an inner structure).

As shown from FIG. 1 to FIG. 3, juicer 1 includes container 2, attachment 3 disposed inside container 2 and configured to squeeze juice from fruits and the like, screw 4 disposed inside attachment 3, lid 5 placed on an upper part of container 2, and main unit 10 on which container 2 is mounted.

Container 2 is a vessel formed of a transparent plastic into a cylindrical shape having an upper part opened. Container 2 is provided, at lower parts of an outer surface, with first spout 21 for discharging juice to the outside and residue port 23 for discharging squeezed-out residue of materials, and both first spout 21 and residue port 23 are in communication to an inner space of container 2. First spout 21 and residue port 23 are cylindrical in shapes that protrude outward from the outer surface of container 2.

Lid 5 is removably attached to the opened upper part of container 2. Lid 5 has feed opening 6 of a cylindrical shape that extends upward. Push rod 7 is inserted in feed opening 6 for pushing materials being fed into container 2.

Attachment 3 includes drum section 8, and rotary brush disposed around drum section 8. Drum section 8 includes net-like portion 8a around an outer periphery, and net-like portion 8a allows juice to pass from the inside to the outside, while preventing the squeezed-out residue from passing therethrough. Screw 4 is disposed inside drum section 8 such that an outer surface of screw 4 stays close to an inner surface of net-like portion 8a. Drum section 8, when inserted into container 2, engages with container 2 into a state of single unit at least in a rotating direction of screw 4.

The materials are squeezed between the outer surface of screw 4 and the inner surface of drum section 8, and juice is extracted through net-like portion 8a and then into a space between container 2 and drum section 8. The squeezed-out residue remains inside drum section 8 without passing through net-like portion 8a.

First spout 21 of container 2 is communicatively connected with the space between the inner surface of container 2 and the outer surface of drum section 8, and residue port 23 is communicatively connected with the space inside drum section 8. A plurality of annular ribs 8b are provided on the outer surface of drum section 8 to improve robustness. A plurality of vertical ribs 8c are provided on the inner surface of drum section 8 to prevent the material from being dragged and rotated with screw 4. There may be a case where drum section 8 is provided with an auxiliary blade, if necessary, to supplement squeezing of the materials.

Rotary brush 9 is disposed between the outer surface of drum section 8 and the inner surface of container 2, and rotated relative to drum section 8 to remove squeezed-out residue and the like of the material that sticks to net-like portion 8a and the like elements.

Main unit 10 has mount section 11 for mounting container 2 on an upper part, and container 2 is removably mounted to main unit 10. Main unit 10 is equipped internally with a drive unit (not shown) for driving screw 4 to rotate, and rotary drive shaft 12 coupled with the drive unit is disposed so that it projects upward at the center of mount section 11.

Rotary drive shaft 12 penetrates through the bottom of container 2 mounted on (attached to) mount section 11, and is coupled detachably to screw 4 disposed in container 2. Screw 4 becomes rotationally driven, under this coupled state, by the drive unit built inside main unit 10 through rotary drive shaft 12. A sealing material (not shown) for preventing leakage of liquid such as juice is disposed in the penetrated portion of rotary drive shaft 12 and the like in the bottom of container 2.

Screw 4 has near a cylindrical shape, and an outer surface of it is provided with spiral portion 4a in proximity to drum section 8 to squeeze the material. As illustrated above, a lower part of screw 4 is coupled to rotary drive shaft 12 of main unit 10. Rotary shaft 4b of screw 4 projects upward from an upper part of screw 4, and rotary shaft 4b is coupled rotatably to an underside of lid 5 attached to container 2.

Description is provided hereinafter about a method for making juice from material such as fruits by using juicer 1 equipped with attachment 3 of the above structure.

First, container 2, rotary brush 9, drum section 8 and screw 4 are set on mount section 11 of main unit 10, and lid 5 is attached to the upper part of container 2. Next, material such as fruits are put in feed opening 6, and pushed into container 2 by using push rod 7. When screw 4 is rotated by the drive unit of main unit 10, the material is squeezed between the outer surface of screw 4 and the inner surface of drum section 8, and juice is extracted into the space between container 2 and drum section 8 through net-like portion 8a. The juice is taken out through first spout 21 of container 2.

Squeezed-out residue of the material remains collected in the bottom of drum section 8 as it does not pass through net-like portion 8a. Afterwards, the squeezed-out residue is discharged from an opening (not shown) formed in the bottom of drum section 8, and then through residue port 23 of container 2.

With rotation of screw 4, rotary brush 9 is also driven to rotate in a direction opposite to screw 4, for instance, so that the squeezed-out residue and the like material that sticks to net-like portion 8a and other elements can be removed by rotary brush 9. The juice is made in this manner with juicer 1 equipped with attachment 3.

Description is provided next of attachment 30 which is replaceable for attachment 3 in juicer 1.

Juicer 1 of the present embodiment may be provided with attachment 30 for making dessert in a form of ice cream or sherbet by crushing frozen material (frozen fruits, for instance) with screw 4.

In a case where frozen material is used, attachment 30 is attached to mount section 11 of main unit 10, instead of attachment 3 (i.e., drum section 8 and rotary brush 9).

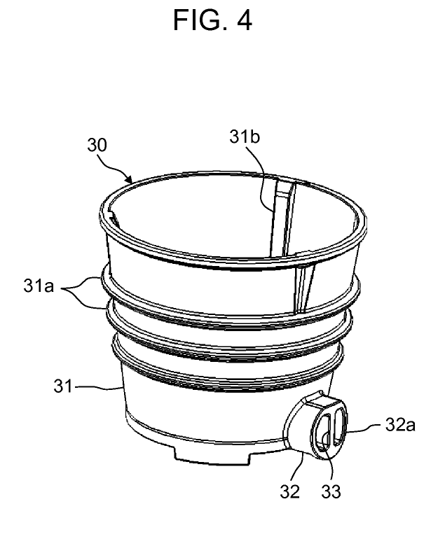

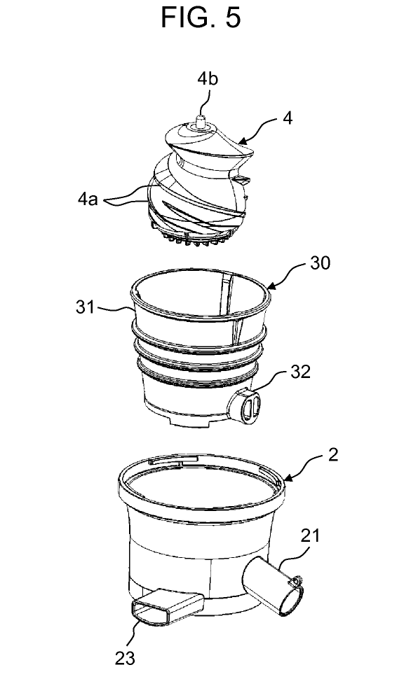

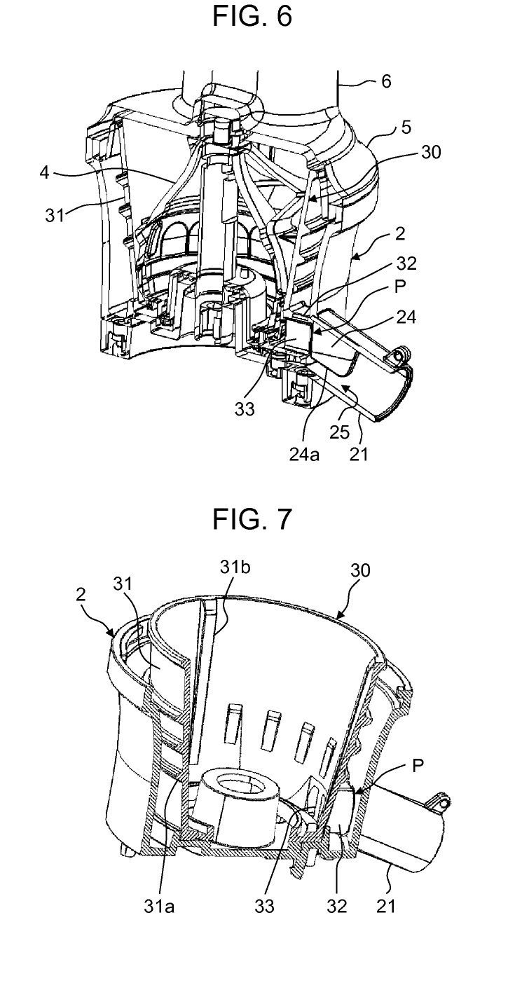

FIG. 4 is an external view of attachment 30, FIG. 5 is an exploded view showing relationship among attachment 30, container 2 and screw 4, and FIG. 6 is a cutaway view of container 2 with attachment 30 in a mounted state.

As shown in FIG. 4, attachment 30 is a closed-bottom container of a cylindrical shape having an opening in an upper part, and formed of a transparent plastic, for example. Attachment 30 is disposed in container 2, and screw 4 is disposed inside attachment 30, as shown in FIG. 5 and FIG. 6.

Attachment 30 includes drum section 31 configured to crush the frozen material between a cylindrical inner surface and an outer surface of screw 4, and second spout 32 connected to an inlet of first spout 21 of container 2 for guiding the crushed material in fluid form into first spout 21. Second spout 32 has a cylindrical shape that protrudes outward from an outer surface of drum section 31.

A plurality of annular ribs 31a are provided on the outer surface of drum section 31 to improve robustness. A plurality of vertical ribs 31b are provided on the inner surface of drum section 31 to prevent the frozen material from being dragged and rotated with screw 4. Screw 4 is disposed inside attachment 30 so that the outer surface of screw 4 stays close to the inner surface of drum section 31.

Attachment 30, when inserted into container 2, engages with container 2 into a state of single unit at least in a rotating direction of screw 4.

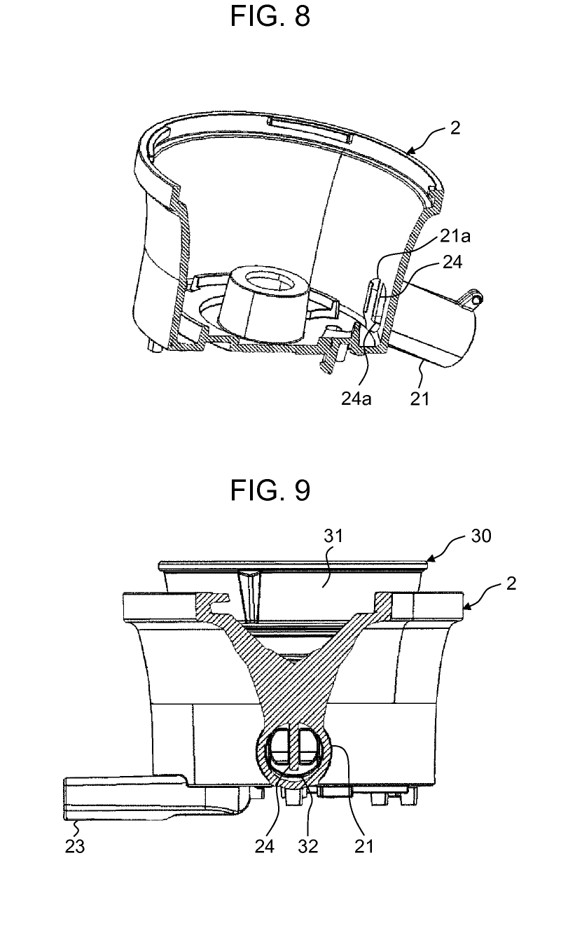

Description is provided now about relationship between second spout 32 of attachment 30 and first spout 21 of container 2 by referring to FIG. 7 to FIG. 9. FIG. 7 is a cutaway view of attachment 30 in a position mounted inside container 2, FIG. 8 is a cutaway view of container 2, and FIG. 9 is an external view (partially sectioned view) of container 2, showing a state when second spout 32 of attachment 30 is observed through first spout 21 of container 2.

Juicer 1 is provided with first rib 24 for preventing insertion of a finger in first spout 21 of container 2 in consideration of safety of the user (refer to FIG. 6, FIG. 8 and FIG. 9). First rib 24 is a plate-like element that extends downward from an inner upper surface of first spout 21 of a cylindrical shape. First rib 24 divides the flow channel inside first spout 21 practically into two passages.

There is space 25 provided between bottom end 24a of first rib 24 and an inner bottom surface of first spout 21. Space 25 provided here helps the material flowing along the inner bottom surface of first spout 21 from not becoming obstructed easily by first rib 24.

First rib 24 is so provided as to extend toward an outlet side (i.e., the outside of container 2) of first spout 21 from an inlet side (i.e., an inner peripheral side of container 2) up to a proximity of the center of the flow channel in first spout 21 (refer to FIG. 6). As illustrated, first rib 24 so provided as to have a certain length along a direction of the flow channel can enhance the effectiveness of preventing insertion of a finger.

Second rib 33 is provided in second spout 32 of attachment 30 at a position corresponding to first rib 24 of container 2, as shown in FIG. 4, FIG. 6 and FIG. 7. To be specific, second rib 33 is provided in a form of plate-like element that extends from an inner top surface to an inner bottom surface of second spout 32 having a cylindrical shape.

With this structure, second rib 33 divides the flow channel of second spout 32 into two passages. Second rib 33 is so disposed as to extend in a direction of the flow channel throughout from an inlet side (i.e., an inner peripheral side of drum section 31) to an outlet side (i.e., the inner peripheral side of container 2) of second spout 32.

Here, the structure that second rib 33 is provided in second spout 32 of attachment 30 at the position corresponding to first rib 24 of first spout 21 means that, when first spout 21 and second spout 32 are viewed in the direction of the flow channel, the position where first rib 24 is formed overlaps with the position where the second rib 33 is formed, and both of them are formed substantially equal in size and shape in the direction of the flow channels (refer to FIG. 9, for instance, as will be described later).

When attachment 30 is disposed in a position inside container 2, outlet end 32a of second spout 32 of attachment 30 is located adjacent to inlet end 21a of first spout 21 of container 2. In other words, outlet end 32a of second spout 32 comes into a state of being connected with inlet end 21a of first spout 21 (at connecting portion P).

When second spout 32 of attachment 30 in this state is observed through first spout 21 of container 2, the flow channel in second spout 32 overlaps substantially with the flow channel in first spout 21 (refer to FIG. 9).

Second rib 33 inside second spout 32 is in a state of substantially overlapping with first rib 24 in first spout 21. Accordingly, two passages of the flow channel divided by second rib 33 inside second spout 32 coincide substantially with two corresponding passages of the flow channel divided by first rib 24 in first spout 21.

Inlet end 21a of first spout 21 of container 2 is formed flush with an inner peripheral surface of the cylindrical shape of container 2. When container 2 is viewed from the upper side, inlet end (i.e., inlet end face) 21a appears to be an arc shape (i.e., curved concave shape) along the inner peripheral surface of container 2. Outlet end 32a of second spout 32 of attachment 30 has an arc shape (i.e., curved convex shape) that protrudes outward, when viewed from the upper side, such that it matches the arc shape of inlet end 21a of first spout 21.

As shown in FIG. 9, a cross sectional area of the flow channel of second spout 32 at the position where second rib 33 is formed in attachment 30 is made smaller than that of the flow channel of first spout 21 at the position where first rib 24 is formed in container 2.

Description is provided about a method for making dessert in a form of sherbet or ice cream called “Yonanas” (Registered Trademark) from frozen material such as frozen fruits by using juicer 1 equipped with attachment 30 of the above structure.

First, container 2, attachment 30 and screw 4 are set on mount section 11 of main unit 10, and lid 5 is attached to the upper part of container 2. Next, frozen material such as frozen fruits is put in feed opening 6, and pushed into a space between screw 4 and attachment 30 inside container 2 by using push rod 7.

As a result of this manipulation, the frozen material is crushed between the outer surface of screw 4 rotated by the drive unit in main unit 10 and the inner surface of drum section 8 of attachment 30. The user can visually check the frozen material in the process of being crushed since both container 2 and attachment 30 are formed of a transparent plastic.

During the process wherein the frozen material is being crushed, the hard frozen material becomes liable to cause deformation of attachment 30 made of plastic.

The shape of attachment 30 can be kept intact, however, due to the plurality of annular ribs 31a formed around the outer surface of drum section 31. The crushed material in fluid form is guided toward first spout 21 of container 2 through second spout 32 of attachment 30. The material of the fluid form is taken out through first spout 21 of container 2, thus produced is the dessert in a form of sherbet or ice cream from juicer 1.

The material of the fluid form produced from crushed frozen material has viscosity higher than that of juice. In second spout 32 of attachment 30 according to the present embodiment, second rib 33 is provided at the position corresponding to first rib 24 provided in first spout 21 of container 2 for preventing insertion of a finger.

Because of this structure, flow of the material in fluid form can be rectified along the two flow passages divided by second rib 33 when passing through second spout 32 from the inside of attachment 30. The material in fluid form is hence guided into first spout 21 from second spout 32 at the connecting portion P between second spout 32 and first spout 21.

Therefore, the material can be guided smoothly into two flow passages divided practically by first rib 24 at inlet end 21a of first spout 21 of container 2, without allowing first rib 24 disposed for prevention of finger insertion in first spout 21 to act as a flow resistance.

As a result, the material in fluid form can be lead smoothly from second spout 32 of attachment 30 into first spout 21 of container 2. It thus becomes possible to prevent the material from leaking into container 2 from the clearance at connecting portion P between first spout 21 and second spout 32.

In addition, outlet end 32a of second spout 32 of attachment 30 is formed into an arc shape (i.e., curved convex shape) in conformity with the arc shape (i.e., curved concave shape) of inlet end 21a of first spout 21 that composes the connecting portion P between first spout 21 and second spout 32.

It is this structure that can make the clearance in the connecting portion P between first spout 21 and second spout 32 uniformly and narrowly throughout the periphery of the connecting portion P. This can further improves the effect of preventing the material from leaking into container 2 from the clearance in the connecting portion P.

The cross sectional area of the flow channel of second spout 32 at the position where second rib 33 is formed in attachment 30 is made smaller than that of the flow channel of first spout 21 at the position where first rib 24 is formed in container 2.

This structure can therefore suppress an increase in the flow resistance in inlet end 21a of first spout 21 when the material in fluid form is being guided from second spout 23 to first spout 21, thereby smoothing the flow of the material

First rib 24 and second rib 33 are desirably disposed adjacent to each other in the light of reducing the flow resistance to the material attributed to first rib 24 of first spout 21. For instance, it is desirable that first rib 24 and second rib 33 are so disposed that the former is located at inlet end 21a of first spout 21 and the latter is located at outlet end 32a of second spout 32.

Second rib 33 is so disposed as to extend in the direction of the flow channel throughout from the inlet side to the outlet side of second spout 32. With this structure, the material that tends to become clogged due to second rib 33 acting as a flow resistance at the inlet side of second spout 32 can be scraped off with screw 4 at the inner surface of drum section 31, thereby smoothing the flow of the material.

Second spout 32 has a cylindrical shape that protrudes outward from the outer surface of drum section 31, and outlet end 32a of second spout 32 is connected with inlet end 21a of first spout 21 of container 2. With this structure, the material can be guided smoothly from second spout 32 to first spout 21 without allowing the material to leak inside container 2 and stick to the inner surface of container 2.

In juicer 1 equipped with attachment 30 of the present embodiment, the material in fluid form can be guided smoothly to first spout 21 of container 2 from inside of attachment 30 through second spout 32, as described above.

As a result, it becomes possible to prevent the material from leaking out at the connecting portion P between second spout 32 and first spout 21. When frozen material is used, it becomes possible to prevent the frozen material from sticking widely to the inner surface of container 2.

In addition, the structure does not require any sealing material to be placed in the connecting portion P between second spout 32 of attachment 30 and first spout 21 of container 2. This helps reduce a number of components in the product, and therefore improve workability in cleaning the product after use.

### VARIATIONS OF THE PRESENT EMBODIMENT

Description is provided next about certain variations of the attachment used for crushing frozen materials and adaptable to juicer 1 of the present embodiment.

Configuration of the first rib provided for prevention of finger insertion in the first spout of container 2 of juicer 1 needs not be limited to a specific form that divides the flow channel in the first spout into two passages (e.g., the configuration of first rib 24 shown in FIG. 9).

The configuration of the first rib may be any form as long as it can exert the effect of preventing insertion of a finger, such that it can be a form that practically divides the flow channel in the first spout into three passages, or another form that divides the flow channel into four or more passages, for instance.

In the second spout of this attachment, the second rib is desirably disposed at a position corresponding to the first rib for prevention of finger insertion provided in the first spout of container 2 (that is, the corresponding shape, size and location).

In an instance of attachment 130 according to a first aspect of variation of the present embodiment, second rib 133 of a tri-radial shape is provided to divide the flow channel into three passages in second spout 132 that protrudes from drum section 131, as shown in FIG. 10.

When the first rib for prevention of finger insertion provided in the first spout of container 2 is formed into the tri-radial shape to divide the flow channel into three passages, it is desirable to dispose second rib 133 of the tri-radial shape at the position corresponding to the first rib in second spout 132. With this structure, the material in fluid form can be guided smoothly into the first spout of container 2 from second spout 132 of attachment 130.

In attachment 130 according to the first aspect of variation shown in FIG. 10, the tri-radial shape of second rib 133 resembles an upright form of the letter Y.

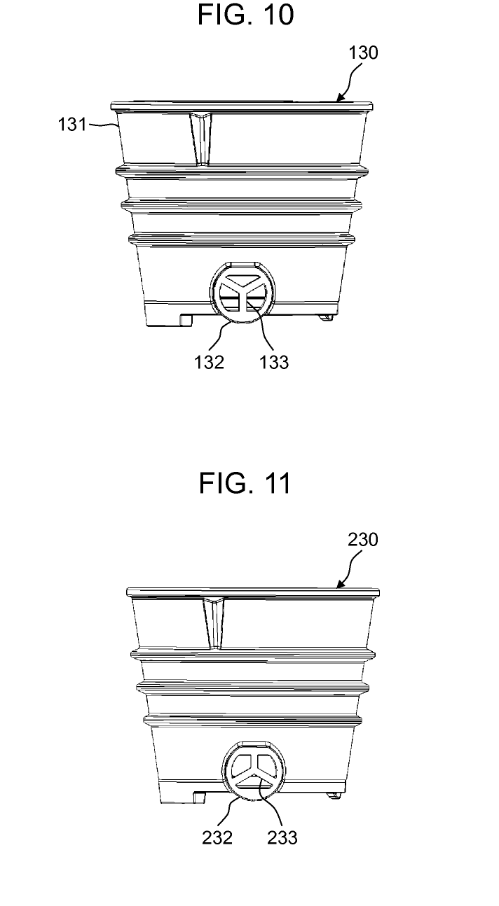

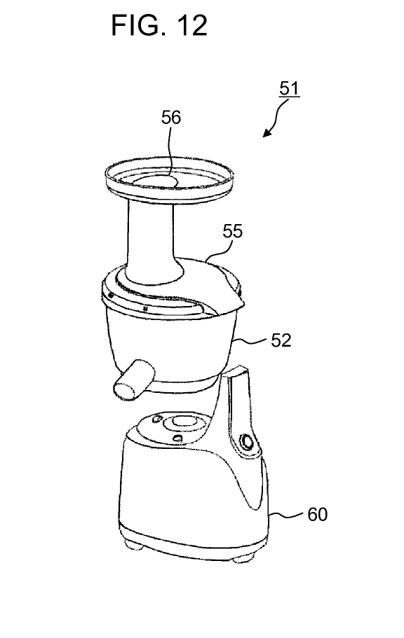

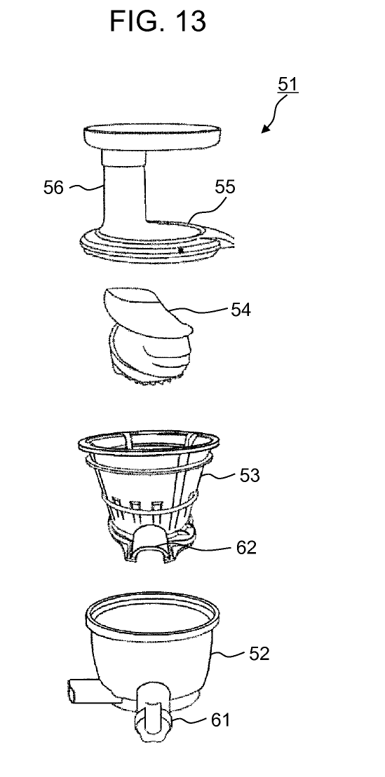

As an alternative to the above, second rib 233 having a tri-radial shape of the letter Y turned upside down (inverted) may be disposed in second spout 232 as an example of attachment 230 according to a second aspect of variation shown in FIG. 11. In this case, the first rib for prevention of finger insertion provided in the first spout of container 2 is formed into the tri-radial shape of the upside-down letter Y.

What has been described in the above exemplary embodiment is the structure in which outlet end 32a of second spout 32 of attachment 30 is connected with inlet end 21a of first spout 21 of container 2.

Here, the term “connected” includes not only the structure in which outlet end 32a of second spout 32 and inlet end 21a of first spout 21 are in contact with each other, but also a structure in which a clearance is maintained between outlet end 32a and inlet end 21a.

For example, the clearance may be provided in consideration of detachability of attachment 30 from inside of container 2. It is desirable, however, that the clearance is determined to be such a dimension that does not allow the frozen material of a large amount turned into fluid form to leak out into container 2.

Although the structure described above is an example of first spout 21 of container 2 in which space 25 is provided between bottom end 24a of first rib 24 for prevention of finger insertion and the inner bottom surface of first spout 21, it may be a structure not provided with space 25.

The structure described above as an example has the cross sectional area of the flow channel of second spout 32 at the position where second rib 33 is formed in attachment 30 that is smaller than that of the flow channel of first spout 21 at the position where first rib 24 is formed in container 2. However, the structure is not restricted by this example.

When the cross sectional area of the flow channel of second spout 32 is formed practically equal to or smaller than that of the flow channel of first spout 21, it can still keep smooth flow of the material without increasing the flow resistance.

Though the description provided above as an example is the structure having attachment 3 constructed from drum section 8 and rotary brush 9, the structure of attachment for squeezing fruit juice and the like is not restricted by the described example. The attachment for squeezing fruit juice and the like may have a structure of various types as long as the structure is capable of squeezing the material between the attachment and the outer surface of screw 4.

Juicer 1 described above as an example has the structure equipped with attachment 30 as a component replaceable with attachment 3. However, the structure may be equipped only with an attachment for crushing frozen materials, and not equipped with another attachment for squeezing fruit juice and the like.

Among the various embodiments described above, desirable types of embodiments may be combined as appropriate to make full use of their advantages.

As has been described, the attachments of the present disclosure are applicable to juicers, and they are useful as attachments especially for making dessert in a form of sherbet or ice cream by crushing frozen materials.

1. A juicer comprising:
a screw configured to be driven and rotated;
an attachment having the screw disposed internally, the attachment configured to crush frozen material between an inner surface and the screw;
a container having a first spout, the container configured to discharge the crushed material crushed in fluid form;
a lid having a feed opening of the material, and placed on an upper part of the container; and
a main unit having a mount section for the container on an upper part, and configured to drive the screw to rotate,
wherein
the attachment includes a drum section configured to crush the frozen material between the inner surface and the screw, and a second spout connected to an inlet of the first spout of the container that guides the crushed material in fluid form into the first spout, and
a first rib is provided in the first spout of the container in order to prevent insertion of a finger, and a second rib is provided in the second spout of the attachment at a position corresponding to the first rib.

2. The juicer of claim 1, wherein a cross sectional area of a flow channel in the second spout at the position where the second rib is provided in the attachment is smaller than a cross sectional area of a flow channel in the first spout at a position where the first rib is provided in the container.

3. The juicer of claim 1, wherein the second rib is provided at least at an outlet side of the second spout of the attachment.

4. The juicer of claim 1, wherein the second rib is so provided as to extend from an inlet side to an outlet side of the second spout of the attachment.

5. The juicer of claim 1, wherein the second spout has a cylindrical shape that protrudes outward from an outer surface of the drum section of the attachment.

6. An attachment provided with a screw internally, configured to be driven and rotated to crush frozen material between an inner surface of the attachment and the screw,
the attachment being used in a juicer that includes a container having a first spout for discharging the crushed material in fluid form, a lid having a feed opening of the material and placed on an upper part of the container, and a main unit having a mount section for the container on an upper part and configured to drive the screw to rotate,
the attachment comprising a drum section configured to crush the frozen material between the inner surface and the screw, and a second spout connected to an inlet of the first spout of the container for guiding the crushed material in fluid form into the first spout, wherein
the attachment has a second rib disposed in the second spout at a position corresponding to a first rib provided in the first spout of the container in order to prevent insertion of a finger.
